(19) United States
(12) Patent Application Publication
(10) Pub. No.: US 2012/0154858 A1
(43) Pub. Date: Jun. 21, 2012

(54) INFORMATION PROCESSING APPARATUS AND METHOD OF CONTROLLING THE SAME

(75) Inventor: Tetsuya Sato, Yokohama-shi (JP)

(73) Assignee: CANON KABUSHIKI KAISHA, Tokyo (JP)

(21) Appl. No.: 13/312,400

(22) Filed: Dec. 6, 2011

(30) Foreign Application Priority Data
Dec. 15, 2010 (JP) 2010-279869

(51) Int. Cl. G06F 3/12

(52) U.S. Cl. 358/1.15

(57) ABSTRACT

An information processing apparatus for displaying a character string on a UI and a method of controlling the apparatus. When a request for a character string to be displayed on the UI is received, a compatible format or incompatible format in which the character string is to be output is selected. When the compatible format is selected, space is inserted around a character string partitioned with a discriminated line feed code, and an output character string in which the number of characters of the character string is adjusted to the number of displayable characters is generated. When the incompatible format is selected, an output character string in which a line feed code is converted to a particular character string is generated. The generated output character string is output.

### BACKGROUND OF THE INVENTION

1. Field of the Invention

The present invention relates to an information processing apparatus to display a character string on a UI and a method of controlling the apparatus.

2. Description of the Related Art

In a known system, an information processing apparatus such as a PC is connected to a Web server of a network, and a resource provided from the Web server such as a Web page is displayed by a Web browser of the information apparatus. Further, among devices such as a Multi Function Peripheral (MFP) having a scanner, a printer and the like, some devices have a Web browser as described above. When a user designates a URL to specify the location of a resource on the network using this Web browser, the resource specified with the URL is provided from the Web server, and the resource is displayed so that the user can browse the resource. Further, in some of the above-described MFPs, as in the case of the PC having a Web browser, an often-browsed URL is arbitrarily named and registered as a “favorite”. This “favorite” is displayed on an operation screen of the MFP as a button. Then, as a title displayed on its button, the registered name is displayed. When the button is depressed by the user, the Web browser is started, the Web browser then obtains the registered URL resource and displays the resource.

The title of the “favorite” button displayed on an operation screen of the MFP can be displayed in plural lines. However, in some of the above-described MFPs, upon registration of a “favorite” name, a line feed code cannot be input. In such case, to display the title of the “favorite” button in plural lines, upon registration, the user inserts space, in consideration of the number of displayable characters per line, around the string, thereby causes overflow of the characters, so as to display the characters in the next line. With this countermeasure, the title is displayed in plural lines.

On the other hand, the above-described MFP has a function of exporting a registered “favorite” as a file. When the file is imported to another MFP by using this function, the same “favorite” as the exported “favorite” can be used in the other MFP. In this case, in an MFP in which a line feed code can be input upon registration of the title of the “favorite”, the line feed code is converted to a particular character string upon export of the “favorite”. Further, upon import, the particular character string is inverse-converted to the line feed code, so that the line feed code can be used after the import. However, when a file including the above-described particular character string is imported to an MFP in which a line feed code cannot be input, as the particular character string cannot be converted to the line feed code, the particular character string is displayed on the button. Accordingly, it is impossible to use the same “favorite” by using the export and import functions between an MFP corresponding to such line feed code and an MFP not corresponding to the line feed code.

As an example of a conventional technique upon transmission/reception of data including a line feed code, Japanese Patent Laid-Open No. 2007-280427 is known. In this technique, upon transmission of text data to another device, a line feed code is converted to another line feed code which can be recognized by any of the sending and receiving devices such that line feed is properly performed even in a different line feed system. With this conversion, the character string is displayed with proper line feed in plural lines even between different line-feed code systems.

In the above-described conventional technique, both devices correspond to a line feed code and the technique is advantageous when the line feed code systems are different. However, the above technique is not applicable to data transmission/reception with a device not corresponding to a line feed code as in the case of the above-described MFP.

### SUMMARY OF THE INVENTION

An aspect of the present invention is to eliminate the above-mentioned problems in the conventional technology.

A feature of the present invention is to enable, even an information processing apparatus in which a character string displayed in a UI does not correspond to a line feed code, to display a character string on the UI as in the case of an information processing apparatus corresponding to a line feed code.

According to an aspect of the present invention, there is provided an information processing apparatus comprising: a storage unit configured to store a character string displayed on a UI; a selection unit configured to, in a case that a request for the character string stored in the storage unit is received, select a compatible format or incompatible format in which the character string is to be output; a first conversion unit configured to, in a case that the selection unit selects the compatible format, insert space around a character string separated with a line feed code, to generate an output character string where the number of characters of the character string is adjusted to a number of displayable characters; a second conversion unit configured to, in a case that the selection unit selects the incompatible format, convert the line feed code to a particular character string so as to generate an output character string; and an output unit configured to output the output character string generated by the first or second conversion unit.

According to an aspect of the present invention, there is provided a method of controlling an information processing apparatus to display a character string on a UI, the method comprising: storing a character string displayed on a UI; in a case that a request for the stored character string is received, selecting a compatible format or incompatible format in which the character string is to be output; in a case that the compatible format is selected in the selecting step, inserting space around a character string separated with a line feed code, to generate an output character string where the number of characters of the character string is adjusted to a number of displayable characters; in a case that the incompatible format is selected in the selecting step, converting the line feed code to a particular character string so as to generate an output character string; and outputting the generated output character string.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an entire configuration of an information processing system according to a first embodiment of the present invention;

FIG. 2 is a block diagram showing a configuration of a multi function peripheral (MFP) according to the first embodiment;

FIG. 3 is a block diagram showing a hardware configuration of an information processing apparatus (PC);

FIG. 4A is a block diagram showing a software module configuration of the MFP;

FIG. 4B is a block diagram showing a software module configuration of the PC;

FIG. 5A depicts a view illustrating an example of a table schematically showing a “favorite” data list managed by the MFP;

FIG. 5B depicts a view illustrating an example of a main menu on a display unit of a consol unit of the MFP;

FIG. 6 is a sequence diagram showing the flow of a series of processings between the PC and the MFP in the information processing system according to the first embodiment;

FIG. 7 depicts a view illustrating an example of an export screen displayed by a Web browser at timing 602 in FIG. 6;

FIG. 8 is a flowchart for describing export file generation processing by the MFP;

FIG. 9 is a flowchart for describing processing by a compatible output data converter in step S804;

FIG. 10 is a flowchart for describing processing by an incompatible output data converter in step S805;

FIG. 11A depicts a view illustrating an example of a compatible export file according to the first embodiment;

FIG. 11B depicts a view illustrating an example of an incompatible export file;

FIG. 12 is a block diagram showing the software configuration of the MFP according to a second embodiment of the present invention;

FIG. 13 is a sequence diagram showing the flow of a series of processings between the PC and the MFP in the information processing system according to the second embodiment;

FIG. 14 is a flowchart for describing import file data conversion processing; and

FIG. 15 is a flowchart for describing compatible title character string conversion processing (step S1407).

### DESCRIPTION OF THE EMBODIMENTS

Embodiments of the present invention are described hereinafter in detail, with reference to the accompanying drawings. It is to be understood that the following embodiment s are not intended to limit the claims of the present invention, and that not all of the combinations of the aspects that are described according to the following embodiments are necessarily required with respect to the means to solve the problems according to the present invention.

First, a first embodiment according to the present invention will be described. In the first embodiment, an MFP as an example of the information processing apparatus exports “favorite” data in response to an export request from a PC.

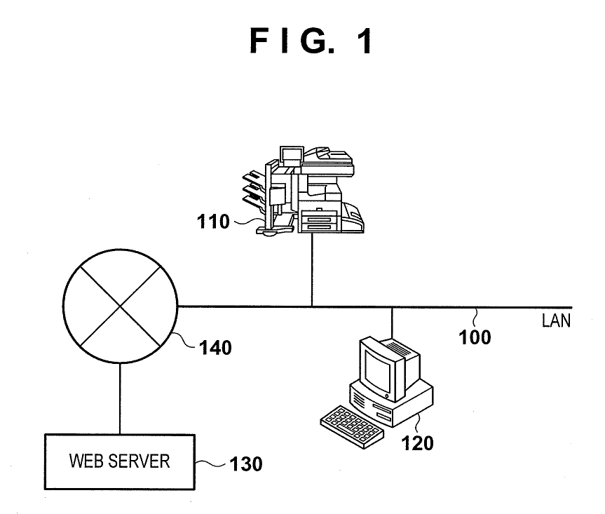

FIG. 1 is a block diagram showing an entire configuration of an information processing system according to a first embodiment of the present invention.

A multi function peripheral (MFP) 110 and an information processing apparatus (PC) 120 are connected to a LAN 100 based on e.g. Ethernet. The LAN 100 is connected to the Internet 140, and information exchange with a Web server 130 on the Internet 140 is possible. The MFP 110 has a copy function, and in addition, has a data transmission function of transmitting image data obtained by reading an original document (also referred to as “document data”) to a designated device on the LAN 100 or the Internet 140 using the FTP (File Transfer Protocol), the SMB (Server Message Block) protocol or the like. Further, the MFP 110 can generate an E-mail with image data as an attached file and transmit the E-mail using an E-mail server (not shown).

Note that in the information processing system according to the first embodiment, the number of devices is not limited to that of the above-described devices. Further, in the first embodiment, the LAN is used as a connection medium, however, the present invention is not limited to this medium. For example, an arbitrary network such as a WAN (public line), a serial transmission method such as USB, a parallel transmission method such as Centronics or SCSI is available.

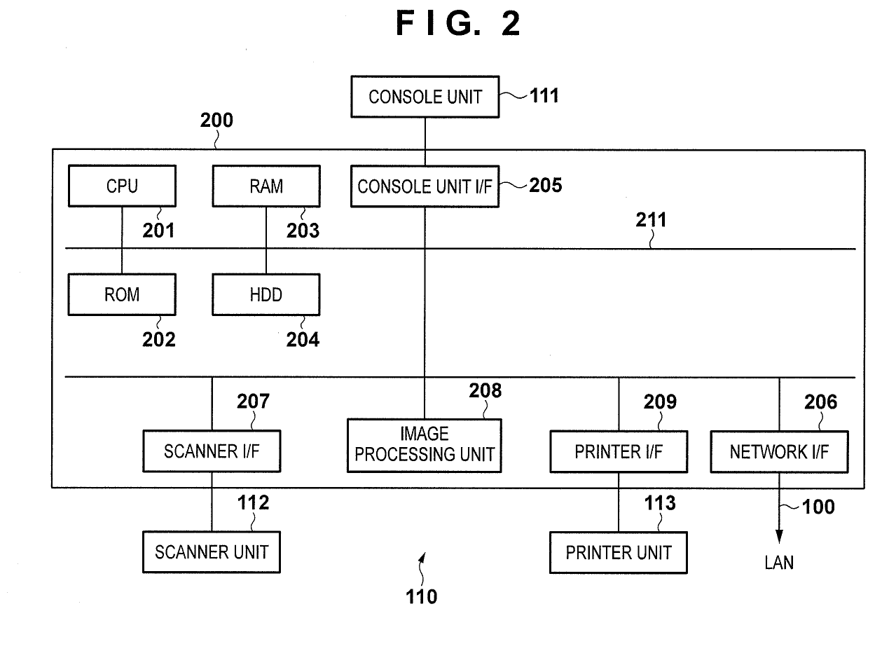

FIG. 2 is a block diagram showing a configuration of the multi function peripheral (MFP) 110 according to the first embodiment.

The multi function peripheral 110 has a scanner unit 112 as an image input device, a printer unit 113 as an image output device, a controller 200 which controls the MFP 110 and a console unit 111.

The scanner unit 112 reads an image of an original document and generates image data. Note that the original documents are set on a document feeder (not shown). When an original document reading instruction is given from the controller 200, the scanner unit 112 performs original document reading operation while feeds the original documents one by one from the document feeder. Note that as the original document reading method, it may be arranged such that the original document is not automatic feeding by the document feeder but the original document is placed on a platen glass (not shown) and scanning on the original document is performed by moving a scanner.

A printer unit 113 forms an image on a print sheet based on the image data received from the controller 200. Note that a printer engine of the printer unit 113 according to the first embodiment is applicable to an ink-jet method in addition to an electrophotographic method using a photosensitive drum or a photosensitive belt.

The controller 200 is electrically connected with the console unit 111, the scanner unit 112 and the printer unit 113, on the other hand, it is connected to the LAN 100 via a network interface 206. That is, the controller 200 is connected to the other devices via the LAN 100. In this arrangement, HTTP protocol communication is possible. A CPU 201 loads a program installed in an HDD 204 to a RAM 203, and based on the program, controls access to various connected devices and access from other devices. In addition, the CPU 201 controls various processings performed in the controller 200. This control includes execution of a program to realize a flowchart to be described later. A ROM 202 holds a boot program. The RAM 203 has a program area for loading a program executed by the CPU 201, and a work memory area for storing various data upon execution of the program. The RAM 203 includes a power-source backed nonvolatile region for storage of stored contents after power-off and a region in which stored contents are erased after power-off. The HDD 204 is a hard disk drive capable of storing system software and image data.

A console unit interface (I/F) 205 is an interface for connection between a system bus 211 and the console unit 111. The console unit I/F 205 receives image data to be displayed on the console unit 111 from the system bus 211, outputs the image data to the console unit 111, and outputs information input from the console unit 111 to the system bus 211. The network interface 206, connected to the LAN 100 and the system bus 211, performs information input/output with respect to the LAN 100. A scanner I/F 207 performs correction, processing and editing on image data received from the scanner unit 112. Note that the scanner I/F 207 has a function of determining whether an original document is a color document or a monochrome document, further, whether the original document is a character document or a photographic document, and the like, based on the image data received from the scanner unit 112. An image processing unit 208 performs rotation, compression, decompression and the like on image data. Further, the image processing unit 208 combines images stored in the HDD 204 into one image. A printer I/F 209 receives image data sent from the image processing unit 208, generates print data while referring to attribute data attached to the image data, and outputs the print data to the printer unit 113. Note that in the first embodiment, the MFP 110 is a network MFP which produces a UI display, however, the MFP 110 may be a general-purpose computer connected to a general-purpose scanner, a general-purpose printer and the like, or may be other image processing apparatus than the computer.

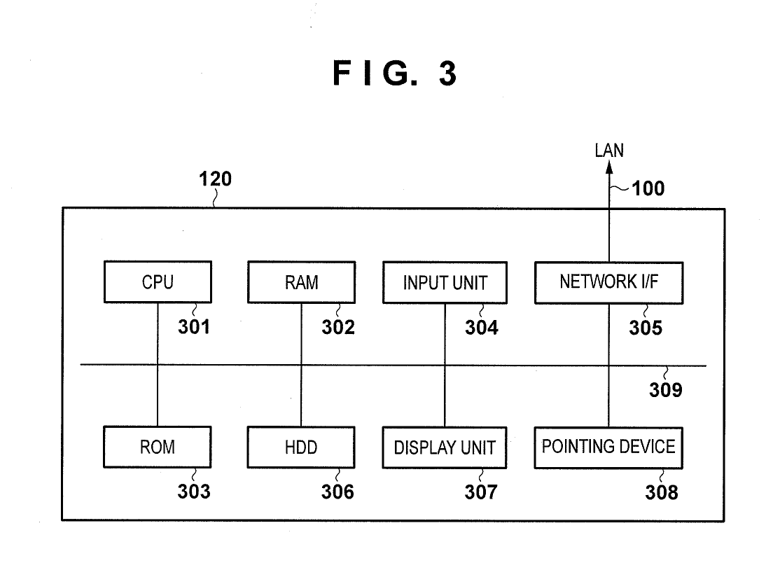

FIG. 3 is a block diagram showing a hardware configuration of the information processing apparatus (PC) 120 according to the first embodiment.

A CPU 301, a RAM 302, a ROM 303, a network interface 305 and a hard disk drive (HDD) 306 are connected mutually communicably via a system bus 309. Further, a display unit 307 such as a CRT or a liquid crystal display, an input unit 304 such as a keyboard and a pointing device 308 are connected mutually communicably via the system bus 309. The HDD 306 holds a control program such as an operating system. The CPU 301 loads the control program from the HDD 306 to the RAM 302 and executes the program with a boot program stored in the ROM 303, to make use of the function of the apparatus as a computer. Further, the CPU 301 displays various information via the display unit 307, and receives a user's instruction or the like from the input unit 304 and the pointing device 308. Further, the CPU 301 performs communication with another device on the LAN 100 via the network interface 305.

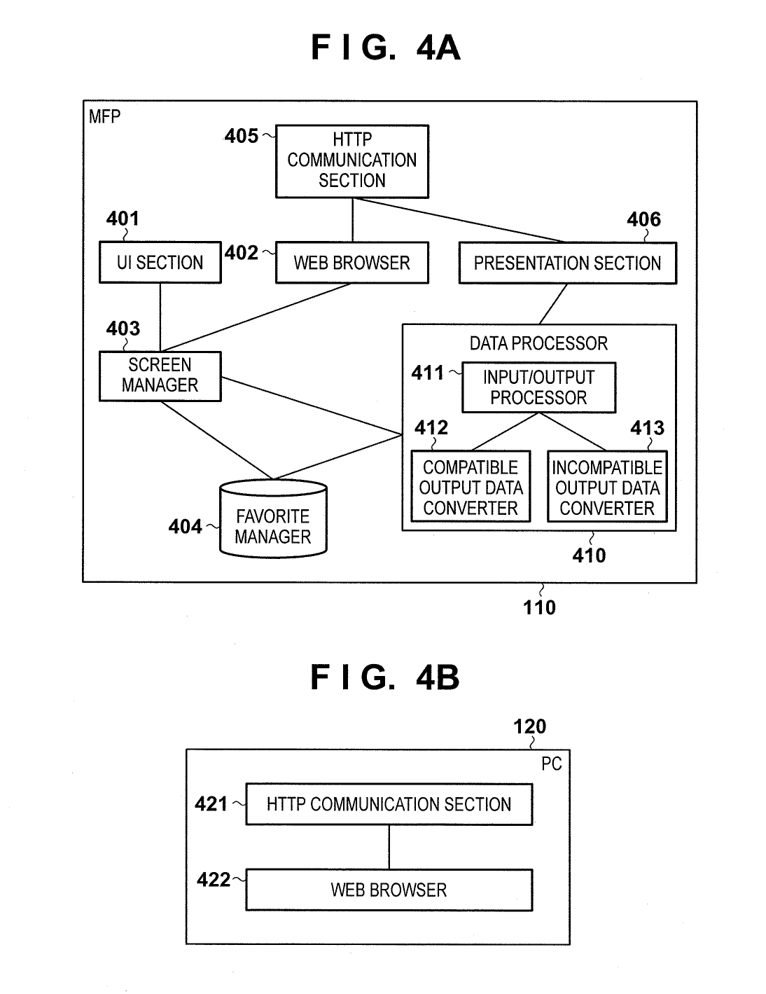

FIG. 4A is a block diagram showing a software module configuration of the MFP 110 according to the first embodiment. These software modules are stored in the HDD 204 of the MFP 110, and executed by the CPU 201.

A UI section 401 is a software module to display UIs for use of the functions of the MFP 110 including a menu UI for function selection, a copy function UI, a data transmission function UI, and an MFP setting UI. A Web browser 402 is a software module to perform communication with the Web server 130 or the like on the network via an HTTP communication section 405. A screen manager 403 is a software module to select a display of module from modules having a UI screen such as the UI section 401 and the Web browser 402. The screen manager 403 displays UIs of respective modules on the console unit 111 via the console unit I/F 205 in accordance with an instruction from another software module. A favorite manager 404 is a software module to manage a URL to specify a resource such as a Web page provided by the Web server 130 through communication with the Web browser 402. The information managed by the favorite manager 404 will be described later.

The HTTP communication section 405 is a software module to perform communication by the HTTP protocol by operating the network I/F 206. A presentation section 406 transmits screen information to be displayed by a Web browser 422 (to be described later) of the PC 120 via the HTTP communication section 405 to the PC 120 in response to a request from the PC 120. Further, the presentation section 406 receives input information from a user input via a screen displayed by the Web browser 422 of the PC 120 via the HTTP communication section 405 from the PC 120.

A data processor 410 has an input/output processor 411, a compatible output, data converter 412 and an incompatible output data converter 413. The data processor 410 processes input information from the PC 120 delivered from the presentation section 406. For example, in response to the user's input on the PC 120, converts “favorite” data managed by the favorite manager 404 to an export file. The input/output processor 411 is a main software module of the data processor 410 to convert data held inside the MFP 110 into a file. Further, the input/output processor 411 converts a file received from the PC 120 into data to be held in the MFP 110. The compatible output data converter 412 and the incompatible output data converter 413 are software modules to convert “favorite” data designated from the input/output processor 411 to data in correspondence with rules of each converter. The explanation of the processing to convert “favorite” data by the respective converters will be described later.

FIG. 4B is a block diagram showing a software module configuration of the PC 120 according to the first embodiment.

An HTTP communication section 421 is a software module to perform communication by the HTTP protocol by operating the network I/F 305. The Web browser 422 is a software module to communicate with the MFP 110 via the HTTP communication section 421. The Web browser 422 issues a screen information acquisition request to obtain HTML screen information to the MFP 110. Further, the Web browser 422 renders HTML data as the screen information received from the MFP 110 via the HTTP communication section 421 and displays the data on the display unit 307, and further, notifies the MFP 110 of an input with respect to an operation screen displayed on the display unit 307.

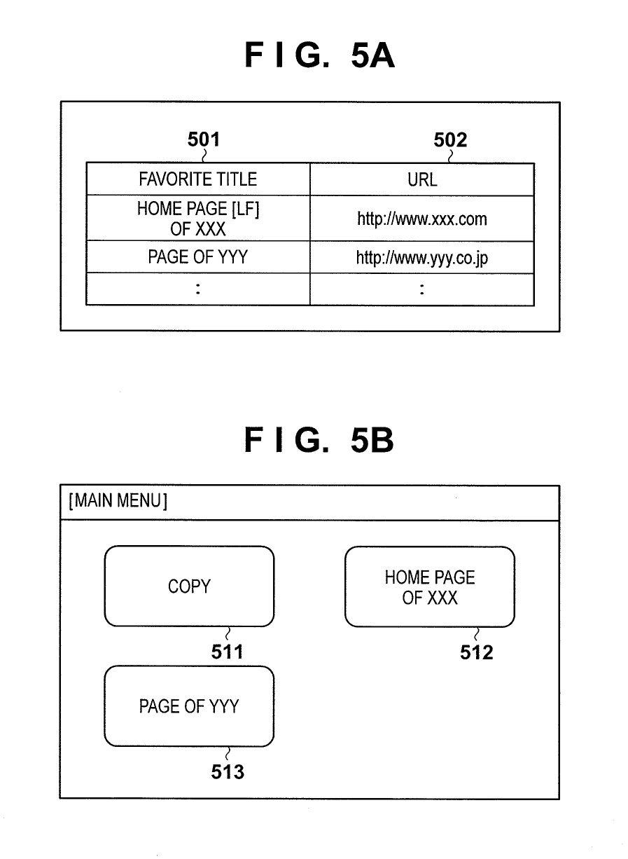

FIG. 5A depicts a view illustrating an example of a table schematically showing a “favorite” data list managed by the favorite manager 404 of the MFP 110 according to the first embodiment. Note that in the first embodiment, the “favorite” data list is stored in the HDD 204 of the MFP 110.

The “favorite” data list has a column 501 and column 502. The column 501 indicates titles of the “favorite” data. For example, in the first title column, “HOME PAGE [LF] OF XXX” is shown. Note that “[LF]” indicates a line feed code as a control character string. In the first embodiment, “[LF]” is used as a line feed code, however, the present invention is not limited to this line feed code. For example, another line feed code such as “[CR]” or “[CR+LF]” may be used. Further, the column 502 indicates URLs corresponding to the “favorite” titles.

FIG. 5B depicts a view illustrating an example of a main menu on a display unit of the consol unit 111 of the MFP 110 according to the first embodiment.

As in this main menu, the UI section 401 obtains button data from the screen manager 403 and displays the obtained button data. A button 511 is a button to call a copy setting screen as a function of the MFP 110. A button 512 is a button to access a URL registered in the favorite manager 404. A title displayed on the button 512 is a title in the first title column of the “favorite” data list (FIG. 5A) managed by the favorite manager 404. Since the MFP 110 handles a line feed code, the character string “HOME PAGE” preceding the line feed code “[LF]” is displayed in the first line, and the character string “OF XXX” following the line feed code “[LF]” is displayed in the second line.

Further, the button displayed on the display unit of the console unit 111 in the first embodiment is displayed using a centering function to move a character string to a central position, and character strings displayed in the respective lines are displayed at the center of the button. For example, when the user depresses the button 512, the UI section 401 notifies the screen manager 403 of the depression of the button 512. The screen manager 403 reads a URL linked to the title on the depressed button 512 from the favorite manager 404. Further, the screen manager 403 switches the screen to the Web browser 402, and requests the Web browser 402 to obtain a resource specified with the URL read from the favorite manager 404. By this request, the Web browser 402 obtains a resource (HOME PAGE OF XXX) of the URL requested from the screen manager 403 with the HTTP communication section 405, and displays the resource on the display unit of the console unit 111.

Further, a button 513 is a button to access a URL registered in the favorite manager 404. The title displayed on the button 513 is a title “PAGE OF YYY” described in the second title column of the “favorite” data list (FIG. 5A) managed by the favorite manager 404.

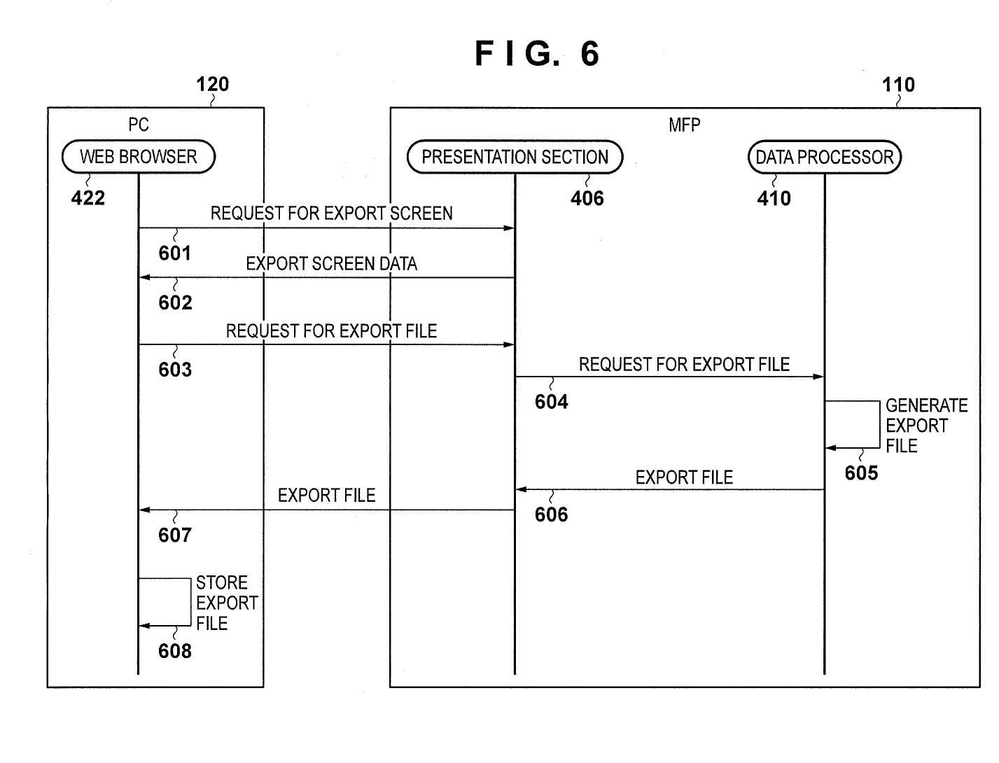

FIG. 6 is a sequence diagram showing the flow of a series of processings between the PC 120 and the MFP 110 in the information processing system according to the first embodiment. Next, the details of “favorite” data export processing performed in the information processing system will be described in accordance with the sequence diagram.

First, in accordance with reception of an operation at the input unit 304 or the pointing device 308 of the PC 120 from the user, the Web browser 422 is started on the PC 120. When the user inputs a URL specifying an export screen of the MFP 110 in an address bar (not shown) displayed by the Web browser 422, an export screen request is sent from the PC 120 to the MFP 110 (601). At this time, a request by the HTTP GET command is issued. More particularly, the Web browser 422 delivers the URL to the HTTP communication section 421. In correspondence with the request, the HTTP communication section 421 of the PC 120 communicates with the HTTP communication section 405 of the MFP 110 by the HTTP protocol. Hereinbelow, the operation between the HTTP communication section 405 and the HTTP communication section 421 will be omitted.

Next, at timing 602, the presentation section 406 of the MFP 110 generates HTML data in response to the export screen request, and transmits the HTML data as an HTTP response to the Web browser 422. With this response, the Web browser 422 analyzes the received HTML data and displays an export screen on the display unit 307 of the PC 120.

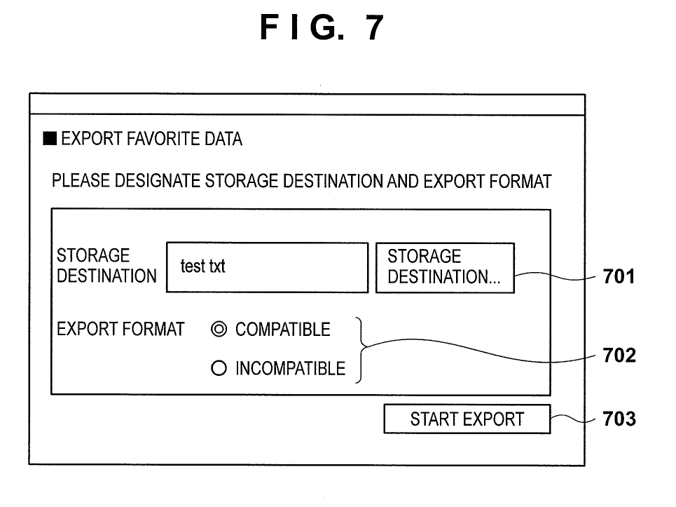

FIG. 7 depicts a view illustrating an example of the export screen displayed on the display unit 307 of the PC 120 by the Web browser 422 at timing 602 in FIG. 6.

In the export screen shown in FIG. 7, a file storage destination to which the “favorite” is exported and an export format can be input. A button 701 is a button to receive a designation of an export file storage destination. When the user depresses the button 701, a screen to designate a file storage destination (not shown) is displayed.

A radio button 702 is a button to receive a selection as to whether the export file is to be exported in a compatible format or in an incompatible format. The processing upon selection of the compatible format and the processing upon selection of the incompatible format will be described later. A button 703 is a button to receive a start of export. When the button 703 is depressed, an export file request instruction is made, and as shown at timing 603 in FIG. 6, the Web browser 422 issues a request for the export file to the presentation section 406 of the MFP 110. This request includes input information input with the radio button 702 in FIG. 7. Next, at timing 604, the presentation section 406 recognizes that the request received at timing 603 corresponds to the export file, and outputs a request for the export file to the data processor 410. Then at timing 605, the data processor 410 generates an export file.

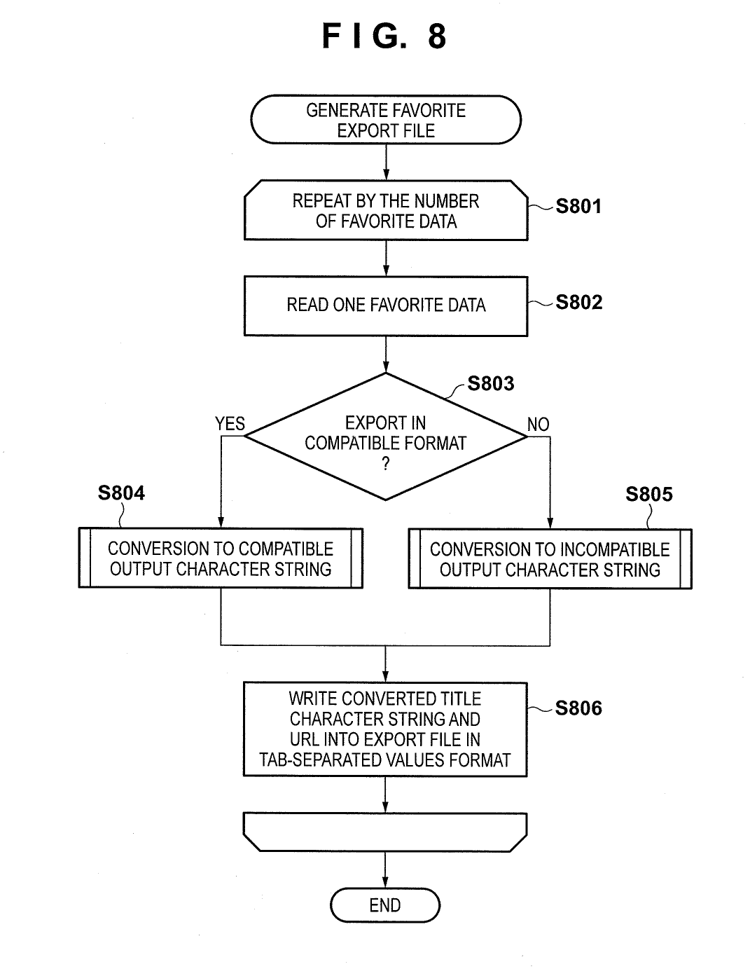

Next, export file generation processing by the data processor 410 will be described in detail with reference to FIGS. 8 to 10.

FIG. 8 is a flowchart for describing the export file generation processing by the MFP 110. A program to execute the processing is installed in the HDD 204, and upon execution, loaded to the RAM 203 and executed under the control of the CPU 201.

In step S801, the CPU 201 determines whether or not processing in steps S802 to S806 has been repeated by the number of favorite data managed by the favorite manager 404. When the repetition has been completed, the processing shown in this flowchart ends. When the repetition is not completed, the process proceeds to step S802. In step S802, the CPU 201 reads one “favorite” data from the favorite manager 404. The “favorite” data is a combination of a title and a URL of “favorite” data in the “favorite” data list. For example, the first “favorite” data in the “favorite” data list has a title “HOME PAGE[LF] OF XXX” and a URL “http://www.xxx.com”.

Next, in step S803, the CPU 201 determines the export format from the received user input information. The user input information indicates information input with the radio button 702 in FIG. 7. When the format is a compatible format, the favorite title is delivered to the compatible output data converter 412, and the process proceeds to step S804. On the other hand, when the format is an incompatible format, the favorite title is delivered to the incompatible output data converter 413, and the process proceeds to step S805.

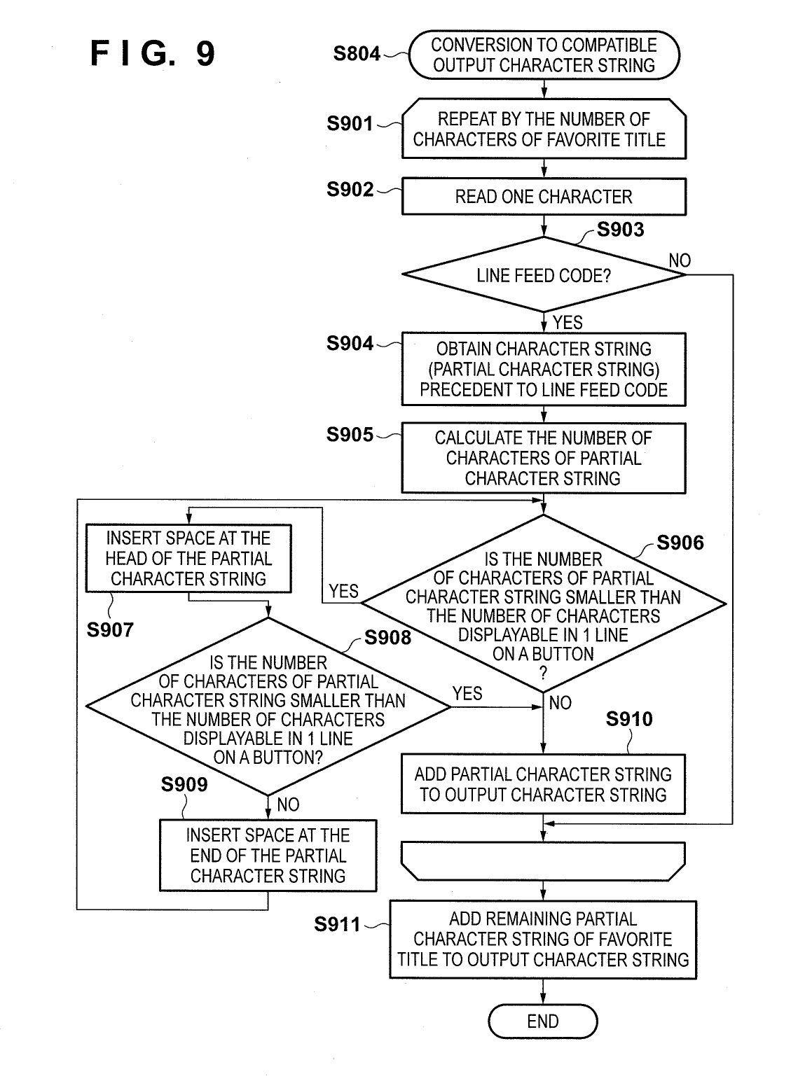

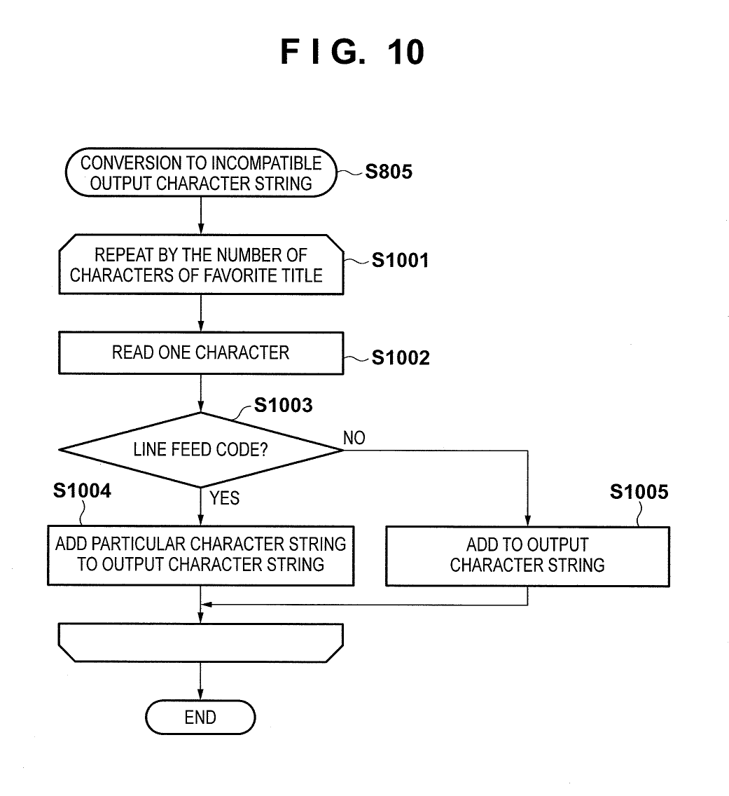

In step S804, the compatible output data converter 412 converts the received favorite title to a compatible output character string, then delivers the converted output character string to the input/output processor 411, and the process proceeds to step S806. The conversion to the compatible “favorite” title will be described later using FIG. 9. On the other hand, in step S805, the incompatible output data converter 413 converts the received “favorite” title into an incompatible output character string, then delivers the converted output character string to the input/output processor 411, and the process proceeds to step S806. The conversion to the incompatible output character string will be described later using FIG. 10.

Then in step S806, the CPU 201 writes the output character string converted in step S804 or S805 and the URL of the “favorite” data, in a tab separated values format, into an export file. In the first embodiment, the tab separated values format is used, however, the format is not particularly determined but may be CSV (Comma Separated Values) format as long as the favorite titles and URLs can be distinguished.

FIG. 9 is a flowchart for describing the details of the processing by the compatible output data converter 412 in step S804. Note that in the following description, the processing by the compatible output data converter 412 will be described as processing by the CPU 201 that controls the compatible output data converter 412.

In step S901, the CPU 201 determines whether or not processing in steps S902 to S910 has been repeated by the number of the “favorite” title characters. When the repetition has been completed, the process proceeds to step S911. When the repetition has not been completed, the process proceeds to step S902. In step S902, the CPU 201 reads one character of the “favorite” title, and the process proceeds to step S903.

In step S903, the CPU 201 determines whether or not the character read in step S902 is a line feed code. When the character is a line feed code, the process proceeds to step S904, in which the character string preceding the line feed code is obtained. For example, in the example of FIG. 5A, the title of the “favorite” title in the first line of the favorite data list is “HOME PAGE[LF] OF XXX”. The tenth character [LF] of the title is the line feed code. Accordingly, in step S903, the character “[LF]” is read then determined as a line feed code, and the process proceeds to step S904. In step S904, the CPU 201 obtains the character string preceding the line feed code (the tenth character) of the title. That is, in the example of FIG. 5A, the character string “HOME PAGE” is obtained. Note that when the second line feed code is found, characters between a character following the first line feed code to a character preceding the second line feed are obtained as a partial character string. In this manner, regardless of the number of line feed codes, plural segmented partial character strings can be similarly obtained.

Next, in step S905, the CPU 201 calculates the number of characters of the partial character string obtained in step S904. Next, the process proceeds to step S906, in which the CPU 201 determines whether or not the number of characters of the partial character string calculated in step S905 is smaller than a maximum number of displayable characters per line of the button displayed on the UI section 401. At this time, if the maximum number of characters is unknown, the CPU 201 makes an inquiry to the screen manager 403, and performs determination using the maximum number of characters received from the screen manager 403. If the number of characters per line is smaller than the maximum number of displayable characters, then the process proceeds from step S906 to step S907. On the other hand, when the number of characters per line is already equal to or larger than the maximum number of displayable characters, the process proceeds from step S906 to step S910. For example, when a partial character string “HOME PAGE” has nine characters, and the maximum number of displayable characters is “12”, the process proceeds to step S907.

Note that in the first embodiment, the number of characters is used as a determination reference, however, it may be arranged such that font, a character pitch and the like are added to the conditions, and the determination is made based on e.g. a width displayable per line as to whether or not the width is equal to or greater than a maximum displayable width.

In step S907, the CPU 201 inserts space at the head of the partial character string. For example, in the partial character string “HOME PAGE”, space is added to the head of the partial character string, then the partial character string is “HOME PAGE”. The number of characters in the partial character string is ten (including spaces). After the addition of the space, the process proceeds to step S908. In step S908, the CPU 201 again determines whether or not the number of characters per line is smaller than the maximum number of displayable characters as in the case of step S906. When the number of characters per line is smaller than the maximum number of displayable characters, the process proceeds to step S909. When the number of characters per line is equal to or greater than the maximum number of displayable characters, the process proceeds to step S910. In step S909, the CPU 201 inserts space at the end of the partial character string. For example, when the partial character string is “HOME PAGE”, space is inserted at the end, then the partial character string is “HOME PAGE”. After the adjustment of the number of characters by insertion of space, the process returns to step S906.

When the number of characters per line is equal to or greater than the maximum number of displayable characters in step S906, the process proceeds to step S910, in which the CPU 201 adds the partial character string to the output character string. For example, when the maximum number of displayable characters of the first partial character string “HOME PAGE” is “12”, the processing in steps S906 to S909 is repeated, then the process proceeds to step S910. The number of characters of the partial character string at this time, with two spaces inserted at the head and one space inserted at the end, in comparison with the first partial character string, “HOME PAGE”, is “12”. Accordingly, the character string is added to the output character string. After the addition to the output character string, the process proceeds to step S911.

In step S911, the CPU 201 adds the remaining character string of the “favorite” title to the output character sting. The remaining character string of the “favorite” title indicates a character string from a character following the last line feed code to the last character of the “favorite” title.

Note that when a line feed code is not found in the “favorite” title, the title is not changed. The remaining character string of the “favorite” title is, e.g., in the first line of the list in FIG. 5A, “HOME PAGE”. In this case, since the output character string includes the character string added in step S910, the final output character string is “HOME PAGE OF XXX”. Thus the CPU 201 (compatible output data converter 412) delivers the output character string to the input/output processor 411. Then the process ends.

Note that in step S906, when the number of characters per line is larger than the maximum number of characters displayable on the button displayed on the UI section 401, the partial character string is added without any change to the output character string. When the output character string is displayed by the apparatus that received the output character string, the title is automatically displayed in plural lines by the maximum number of displayable characters per line. The remaining character string (the second line and the subsequent character string) is displayed in center-aligned state.

FIG. 10 is a flowchart for describing the processing by the incompatible output data converter 413 in step S805. Note that in the following description, the processing by the incompatible output data converter 413 will be described as processing by the CPU 201 that controls the compatible output data converter 413.

In step S1001, the CPU 201 determines whether or not processing in steps S1002 to S1005 has been repeated by the number of characters of the favorite title. When the repetition has been completed, the CPU 201 delivers the output character string to the input/output processor 411, and the process ends. When the repetition has not been completed, the process proceeds to step S1002. In step S1002, the CPU 201 reads one character of the “favorite” title, then the process proceeds to step S1003. In step S1003, the CPU 201 determines whether or not the read character is a line feed code. When the character is a line feed code, the process proceeds to step S1004. When the character is not a line feed code, the process proceeds to step S1005. In step S1004, the CPU 201 adds a particular character string to the output character sting. The particular character string is a character string, linked to a line feed code, managed by the data processor 410 of the MFP 110. For example, when the particular character string is “<!ret>”, the character string “<!ret>” is added to the output character string. Thus, after the addition of the particular character string, the process proceeds to step S1001. On the other hand, in step S1005, the CPU 201 adds the character read in step S1002 to the output character string as it is. Thus, after the addition of the character, the process proceeds to step S1001.

For example, in the case of the title “HOME PAGE[LF] OF XXX” in the first line of the list shown in FIG. 5A, the “favorite” title is processed in accordance with the flowchart of FIG. 10, and the output character string is “HOME PAGE<!ret>OF XXX”.

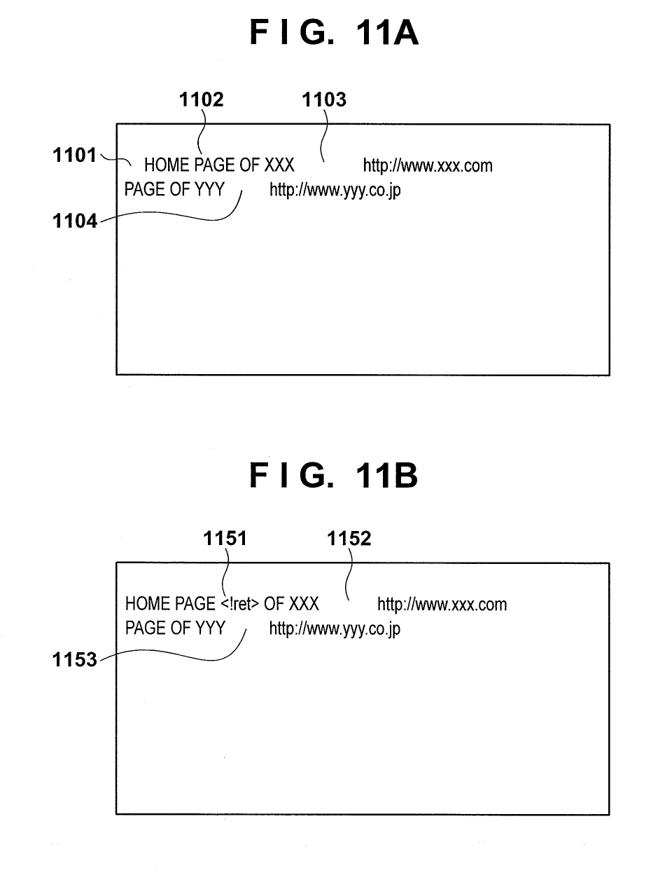

FIG. 11A depicts a view illustrating an example of a compatible export file generated from “favorite” data in the “favorite” data list.

The compatible export file in FIG. 11A is a text file. Space 1101 is space added in step S907 (FIG. 9). Space 1102 is space inserted in step S909. Tabs 1103 and 1104 are tabs added in step S806 (FIG. 8).

When this compatible export file is imported by an MFP not corresponding to the line feed code (not shown), the number of characters overflows at the end of the space 1102, and the subsequent characters are displayed from the next line. Accordingly, after the import, even in the main menu of the MFP not corresponding to the line feed code, the title can be displayed in two lines as shown in the main menu In FIG. 5B. For example, in the button 512, “HOME PAGE” is displayed in the first line, then “OF XXX” is displayed in the second line, and further, the title is centered.

FIG. 11B depicts a view illustrating an example of an incompatible export file generated from “favorite” data in the favorite data list.

The incompatible export file in FIG. 11B is a text file. A character string 1151 “<!ret>” is the particular character string added in step S1004 in FIG. 10. Tabs 1152 and 1153 are tabs added in step S806 in FIG. 8. The export file has no space in comparison with the export file in FIG. 11A. Accordingly, after the export, when the file is to be edited with a text editor installed in a PC or the like, it is possible to perform editing without conscious of the number of spaces or the like.

Returning to FIG. 6, at timing 606, the data processor 410 delivers the export file generated at timing 605 to the presentation section 406. Then at timing 607, the presentation section 406 sends the export file to the Web browser 422 of the PC 120. At timing 608, the Web browser 422 stores the received export file in the storage destination designated using the button 701 in FIG. 7.

As described above, according to the first embodiment, by generating a compatible export file, even in an MFP not corresponding to a line feed code, a UI can be displayed on an operation screen as in the case of an MFP corresponding to the line feed code.

Further, by enabling generation of an export file even though the export file is incompatible, file editing after export can be facilitated.

Next, a second embodiment of the present invention will be described. In the above-described first embodiment, an example related to export has been explained. In the second embodiment, an example of import to handle any of a compatible exported file and an incompatible exported file will be described. Note that the system configuration, the hardware configuration of the MFP 110, and the hardware configuration of the PC 120 are the same as those in the first embodiment, accordingly, the explanations of the configurations will be omitted.

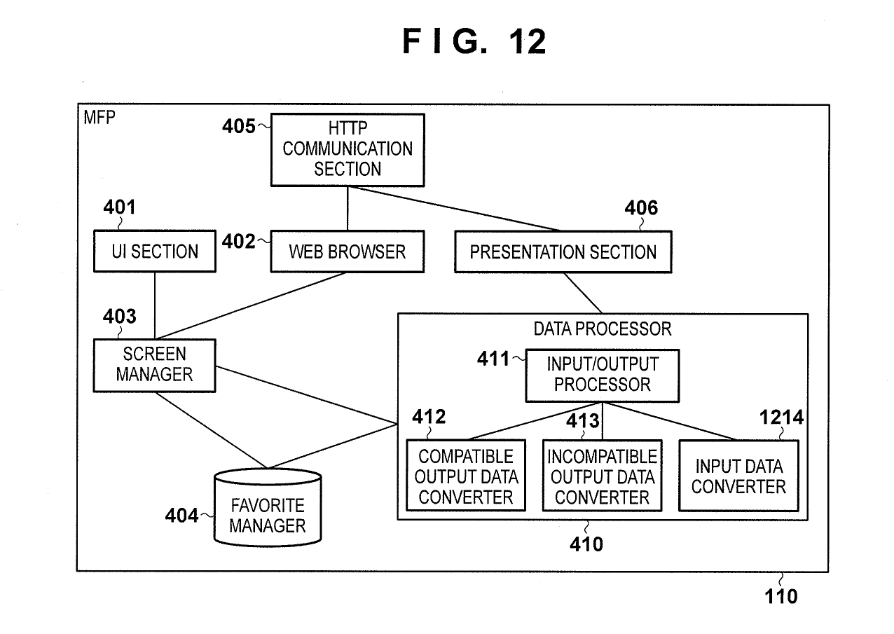

FIG. 12 is a block diagram showing the software configuration of the MFP 110 according to the second embodiment of the present invention. Note that the elements corresponding to those in FIG. 4A of the first embodiment have the same reference numerals, and the explanations of the elements will be omitted.

An input data converter 1214 is a software module, included in the data processor 410, to convert a character string delivered from the input/output processor 411. The conversion processing by the input data converter 1214 will be described later.

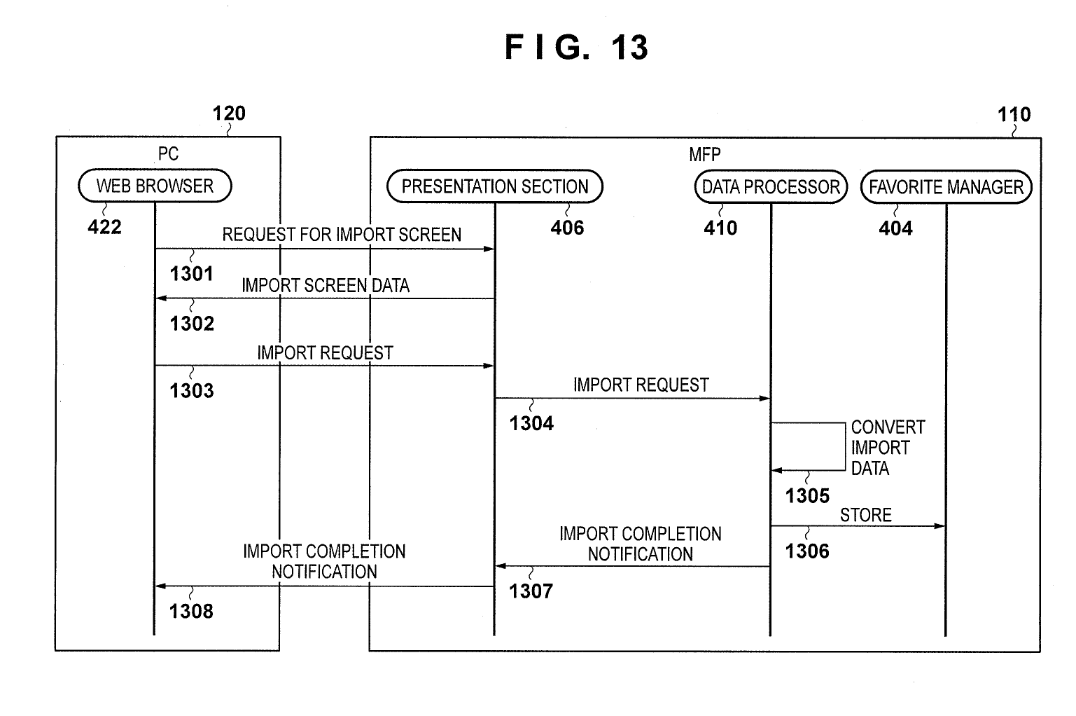

FIG. 13 is a sequence diagram showing the flow of a series of processings between the PC 120 and the MFP 110 in the information processing system according to the second embodiment. Next, the details of “favorite” data import processing performed in the information processing stem will be described in accordance with the sequence diagram.

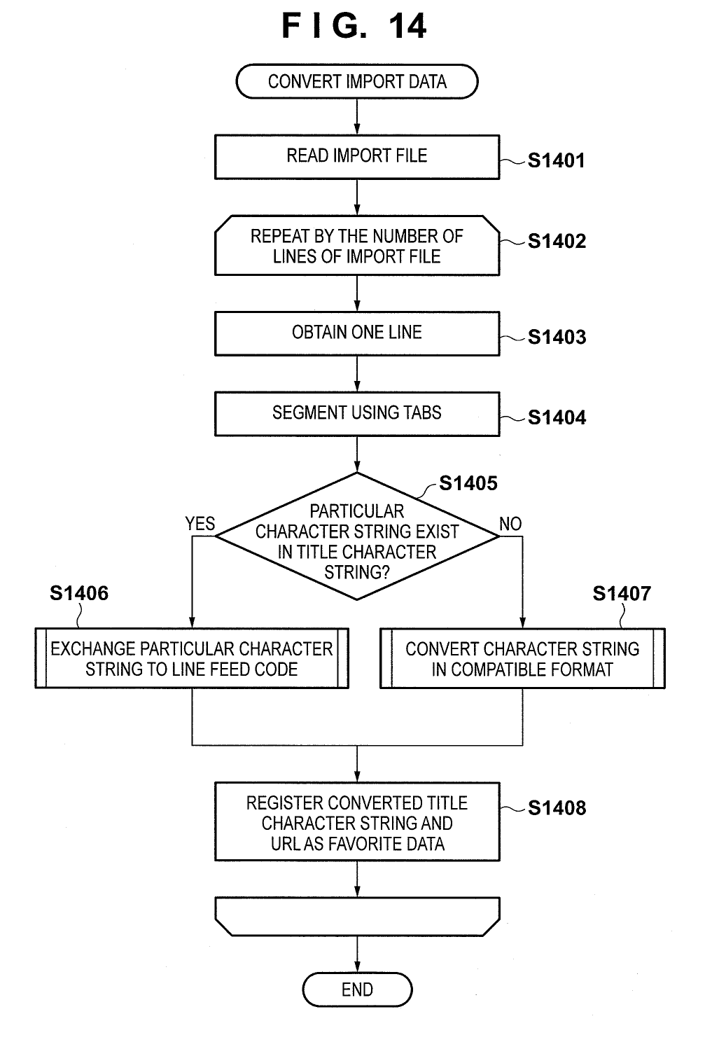

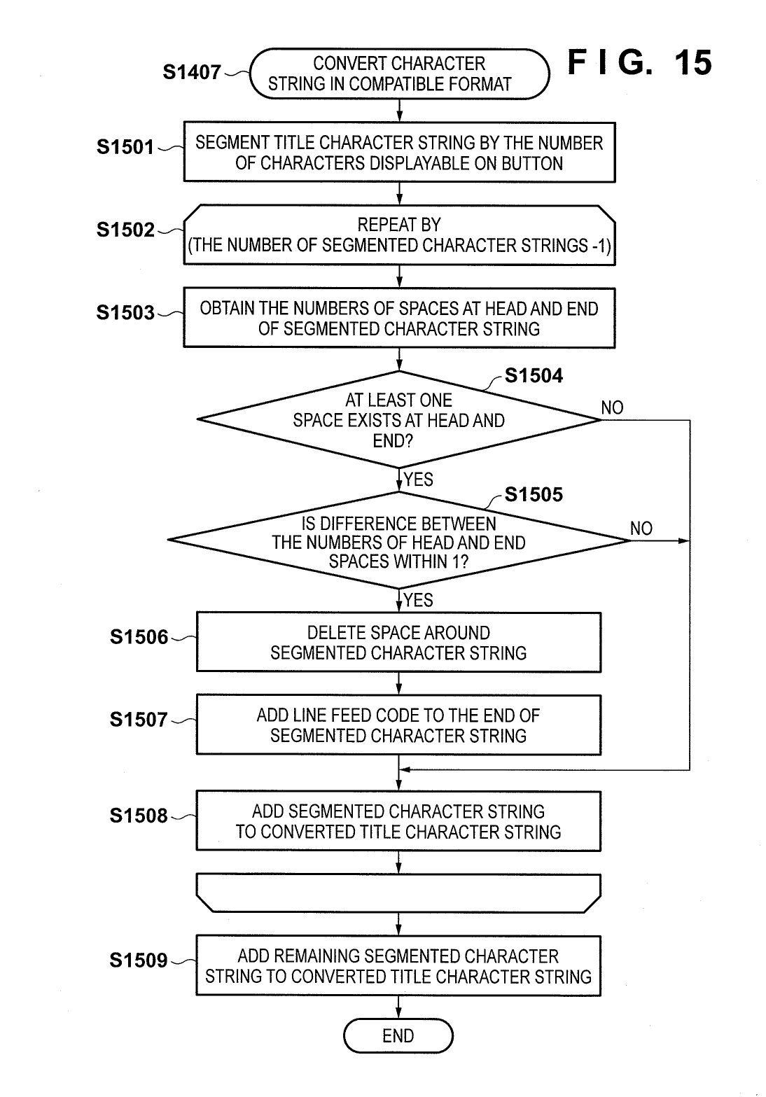

First, the user starts the Web browser 422 by operating the input unit 304 or the pointing device 308 of the PC 120. When the user inputs a URL to specify an import screen of the MFP 110 on an address bar (not shown) displayed by the Web browser 422, import screen request is designated. At timing 1301, an import screen request is issued by an HTTP GET command to the MFP 110. Next, at timing 1302, the presentation section 406 of the MFP 110 generates HTML data in response to the import screen request, and transmits the import screen data as an HTTP response to the Web browser 422. The Web browser 422 analyzes the received HTML data, and displays an import screen on the display unit 307. In the import screen, designation of a file to be imported is received. Further, an import start instruction is received. Upon reception of the import start instruction, at timing 1303, the Web browser 422 of the PC 120 issues an import request to the presentation section 406 of the MFP 110. The import request includes the file designated in the import screen. Next, at timing 1304, the presentation section 406 determines that the received request is an import request, and requests the data processor 410 to perform import. Then at timing 1305, the data processor 410 converts the import file data. Next, the processing at timing 1305 using FIGS. 14 and 15 will be described.

FIG. 14 is a flowchart for describing the import file data conversion processing.

First, in step S1401, the input/output processor 411 reads an imported file, and the process proceeds to step S1402. The imported file is a file included in the import request at timing 1301 in FIG. 13. Next, in step S1402, the CPU 201 determines whether or not processing in steps S1403 to S1408 has been repeated by the number of lines of the imported file. When the repetition has not been completed, the process proceeds to step S1403. When the repetition has been completed, the process ends. For example, when the export file shown in FIG. 11A is imported, as the title is to be displayed in two lines, the processing in steps S1403 to S1408 is repeated twice.

Next, in step S1403, the CPU 201 obtains one line as a character string, from the import file, and the process proceeds to step S1404. In step S1404, the CPU 201 segments the character string obtained in step S1403 using tabs. For example, when the export file in FIG. 11A is a file to be imported and the character string in the first line is obtained, the character string is segmented into “HOME PAGE” and “http://www.xxx.com”. The first segmented character string is handled as a title character string. Further, the second segmented character string is handled as a URL character string. The CPU 201 delivers the title character string to the input data converter 1214, and the process proceeds to step S1405. In step S1405, the CPU 201 determines whether or not a particular character sting exists in the received title character string. The particular character string is a character string linked to a line feed code. For example, when the particular character string is “<!ret>”, the export file shown in FIG. 11B is a file to be imported, and the title character string in the first line is “HOME PAGE<!ret>OF XXX”, as the character “<!ret>” exists, it is determined that a particular character string exists. If the particular character string is included, the process proceeds to step S1406. If the particular character string is not included, the process proceeds to step S1407.

In step S1406, the CPU 201 exchanges the particular character string with a line feed code. For example, when the title character string is “HOME PAGE <!ret>OF XXX”, the character string “<!ret>” is converted to a line feed code “[LF]”. As a result, the title character string is “HOME PAGE[LF] OF XXX” and is displayed in two lines. Thus, after the exchange, the converted title character string is delivered to the input/output processor 411, and the process proceeds to step S1408.

On the other hand, in step S1407, the CPU 201 determines that the title character string is compatible, and performs conversion on the title character string. The details of the processing in step S1407 will be described using FIG. 15. After the conversion of the title character string, the converted title character string is delivered to the input/output processor 411, and the process proceeds to step S1408. In step S1408, the CPU 201 stores the converted title character string, obtained in step S1406 or step S1407, as a favorite title, in association with the URL, as “favorite” data, and the process proceeds to step S1402.

FIG. 15 is a flowchart for describing the compatible title character string conversion processing (step S1407).

In step S1501, the CPU 201 segments the title character string by a maximum number of characters per line displayable on the button. If the maximum number of displayable characters in button is not stored in the input data converter 1214, the CPU 201 requests the screen manager 403 to send the maximum number of displayable characters, and the CPU 201 uses the obtained maximum number of displayable characters in determination upon segmentation of character string. For example, when the title character string is “HOME PAGE OF XXX” and the maximum number of displayable characters on the button is “12”, the CPU 201 segments the title character string into “HOME PAGE” and “OF XXX”. Further, a converted title character string is defined. The converted title character string is used in the subsequent processing. After the division, the process proceeds to step S1502.

In step S1502, the CPU 201 determines whether or not processing in steps S1502 to S1508 has been repeated by a number obtained by subtracting “1” from the number of the title characters, segmented in step S1501. When the repetition has been completed, the process proceeds to step S1509. When the repetition has not been completed, the process proceeds to step S1503. In step S1503, the CPU 201 obtains the number of spaces at the head and end of the segmented character string, stores the respective numbers, and the process proceeds to step S1504.

Next, in step S1504, the CPU 201 determines whether or not one of the numbers of the head and end spaces obtained in step S1503 is not “0”. If one of the numbers is not “0”, the process proceeds to step S1505. If the both numbers are “0”, the process proceeds to step S1508. In step S1505, the CPU 201 determines the difference between the numbers of the head and end spaces is within “1”. If the difference is within “1”, the CPU 201 determines that conversion to a line feed code is necessary, and the process proceeds to step S1506. If the difference is equal to or greater than “2”, the process proceeds to step S1508. For example, when the number of head spaces is “2” and the number of end spaces is “1”, as the difference between the numbers of spaces is “1”, it is determined that the difference is within “1”. Next, in step S1506, the CPU 201 deletes all the head and end spaces of the segmented character string, and the process proceeds to step S1507. For example, when the segmented character string is “HOME PAGE”, the head and end spaces are deleted, and the character string becomes “HOME PAGE”.

In step S1507, the CPU 201 adds the line feed code to the end of the segmented character string processed in step S1506, and the process proceeds to step S1508. For example, when the segmented character string is “HOME PAGE”, the character string after the addition of the line feed code is “HOME PAGE[LF]”. Next, the process proceeds to step S1508, in which the CPU 201 adds the segmented character string to the converted title character string, and the process proceeds to step S1502. For example, when the converted title character string is blank and the segmented character string is “HOME PAGE[LF]”, the title character string after the conversion is “HOME PAGE[LF]”. In step S1509, the CPU 201 adds the remaining segmented character string to the converted title character string. For example, when the segmented character strings are “HOME PAGE” and “OF xxx”, the character string “HOME PAGE” is processed by the processing in steps S1503 to S1508, while the character string “OF XXX” is not processed. The character string “OF XXX” is not processed by the processing in steps S1503 to S1508 since a line feed code is not necessary in a character string displayed in the final line in the button. Accordingly, the remaining character string is added to the converted title character string in step S1509. Finally, the converted title character string becomes “HOME PAGE[LF] OF XXX” in two lines. The above-described processings are the details of the processing at timing 1305 in FIG. 13.

Returning to FIG. 13, at timing 1306, the data processor 410 registers all the “favorite” character string data stored in step S1408 in FIG. 14 into the favorite manager 404. Then at timing 1307, the data processor 410 delivers an import completion notification to the presentation section 406. Next, at timing 1308, the presentation section 406 transmits the import completion notification to the Web browser 422 of the PC 120.

As described above, regardless of whether the imported file is compatible or incompatible, it is possible to perform conversion to a line feed code and perform import.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g. computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-279869, filed Dec. 15, 2010 which is hereby incorporated by reference herein in its entirety.

What is claimed is:

1. An information processing apparatus comprising:
a storage unit configured to store a character string displayed on a UI;
a selection unit configured to, in a case that a request for the character string stored in the storage unit is received, select a compatible format or incompatible format in which the character string is to be output;
a first conversion unit configured to, in a case that the selection unit selects the compatible format, insert space around a character string separated with a line feed code, to generate an output character string where the number of characters of the character string is adjusted to a number of displayable characters;
a second conversion unit configured to, in a case that the selection unit selects the incompatible format, convert the line feed code to a particular character string so as to generate an output character string; and
an output unit configured to output the output character string generated by the first or second conversion unit.

2. The information processing apparatus according to claim 1, wherein the selection unit selects the compatible format or the incompatible format in which the character string is to be output, based on information included in the request for the character string.

3. An information processing apparatus comprising:
an input unit configured to input a character string to be displayed on a UI;
a display unit configured to display the character string input by the input unit on the UI;
a conversion unit configured to convert a particular character string, included in the character string input by the input unit, to a line feed code, so as to generate character string data;
a segmentation unit configured to, in a case that the character string input by the input unit does not include the particular character string, segment the input character string into a plurality of character strings in correspondence with the number of characters displayable in one line on the UI;
a generation unit configured to, in a case that any one of the plurality of character strings segmented by the segmentation unit include space around the character string, delete the space to generate character string data in which a line feed code is inserted at the end of the character string; and
a control unit configured to control the display unit to produce a display on the UI based on the character string data converted by the conversion unit or the character string data generated by the generation unit.

4. A method of controlling an information processing apparatus to display a character string on a UI, the method comprising:
storing a character string displayed on a UI;
in a case that a request for the stored character string is received, selecting a compatible format or incompatible format in which the character string is to be output;
in a case that the compatible format is selected in the selecting step, inserting space around a character string separated with a line feed code, to generate an output character string where the number of characters of the character string is adjusted to a number of displayable characters;
in a case that the incompatible format is selected in the selecting step, converting the line feed code to a particular character string so as to generate an output character string; and
outputting the generated output character string.

5. A method of controlling an information processing apparatus to display a character string on a UI, the method comprising:
inputting a character string to be displayed on a UI;
displaying the input character string on the UI;
converting a particular character string, included in the input character string, to a line feed code so as to generate character string data;
in a case that the input character string does not include the particular character string, segmenting the input character string into a plurality of character strings in correspondence with the number of characters displayable in one line on said UI;
in a case that any one of the plurality of character strings segmented in the segmenting step includes space around the character string, deleting the space so as to generate character string data in which a line feed code is inserted at the end of the character string; and
controlling the displaying step to produce a display on the UI based on the character string data converted in the converting step or the generated character string data.
